(19) United States
(12) Patent Application Publication
(10) Pub. No.: US 2019/0194987 A1
(43) Pub. Date: Jun. 27, 2019

(54) LATCHES

(71) Applicant: Hewlett-Packard Development Company, L.P., Spring, TX (US)

(72) Inventors: Kevin Lo, Vancouver, WA (US); Michael K Bowen, Vancouver, WA (US)

(21) Appl. No.: 16/330,823

(22) PCT Filed: Sep. 7, 2016
(86) PCT No.: PCT/US2016/050562

§ 371 Date: Mar. 6, 2019

(51) Int. Cl. E05C 19/04; E05B 65/00; G03G 21/16

(52) U.S. Cl. CPC E05C 19/04; E05Y 2900/606; G03G 21/1633; E05B 65/006

(57) ABSTRACT

In an example, a panel may include a latch. An example latch may include a wheel, a housing engaged with the wheel, and a bias member to bias the wheel and housing. The housing and wheel may move together along a side of the panel, and the bias member may bias the housing and wheel against the direction of movement of the housing and wheel. The bias member may exert a reactive force against the panel.

### BACKGROUND

Devices such as electronic devices or imaging devices may perform actions on or with media. Devices may print, scan, copy, or perform other actions on or with the media. Further, devices may transport media throughout the device. Devices may have panels or doors that may be opened or removed in order to provide access to internal portions of the device.

### BRIEF DESCRIPTION OF THE DRAWINGS

FIG. 1 is a side view of an example latch.

FIG. 2A is a perspective view of an example device having an example latch.

FIG. 2B is a perspective view of an example device having an example latch.

FIG. 3A is a side view of an example latch.

FIG. 3B is a side view of an example latch.

FIG. 3C is a side view of an example latch.

FIG. 4A is a side view of an example latch.

FIG. 4B is a side view of an example latch.

FIG. 4C is a side view of an example latch.

### DETAILED DESCRIPTION

Devices such as imaging devices, or other electronic devices for example, may perform actions on or with media, or a medium thereof. The devices may print, scan, copy, or perform other actions on or with the media. Further, devices may transport media throughout the imaging device, and/or through a media path of the device. Additionally, devices may include systems, mechanics, assemblies, or other internal components, such as media paths and components thereof, for example, disposed within the device. In some situations, it may be desirable to have the ability to access such internal components or systems for maintenance, repair or replacement of parts, clearing malfunctions or jams, or for other purposes. Devices such as imaging devices or other electronic devices may have openable or removable panels to provide access to internal portions of the device. In some situations, openable panels may comprise a portion or portions of the exterior housing, case, or body of the device.

In some situations, devices may include internal components disposed on such openable panels. Additionally, such openable panels may be removably attached or assembled to the device, or may be hingeably attached to the device such that the openable panel or panels may swing away from the device, or a chassis thereof, in a similar fashion to a door. In further situations, internal components or systems disposed on the openable panel, or the weight or mass thereof, may cause the panel to sag or deflect from the device when the panel is in an opened position. The panel may sag from a hinged side of the panel, wherein the panel is hingeably engaged with the device, or a chassis thereof, at the hinged side. In some situations, the panel may sag to such a degree that the panel may be misaligned with the device, and/or the sagging may prevent the panel from fully closing against the device, or may otherwise inhibit the correct or complete closing of the panel against the device.

In further situations, an openable panel of a device may include a guide feature to assist the panel in closing against the device, or a chassis thereof. The guide feature may include a chamfered or angled feature or geometry to help correctly align the panel with the device for proper closing. However, in some situations, the weight of the panel, or internal components disposed thereon, may cause the panel to sag when in the open position to such a degree that the guide feature cannot help correct the alignment of the panel. In other words, the panel may sag to such a degree that the guide feature is completely misaligned from a receiving geometry or feature on the device, and therefore the panel may be incapable of closing correctly without external assistance, for example, from a user. Additionally, in some situations, the panel may be misaligned with the device such that the guide feature of the panel may interfere with the device or chassis thereof as the panel is closed, and/or the guide features may experience sliding friction as the guide features are engaged with a receiving geometry or feature as the panel is closed. Such friction may make it more difficult to close the panel correctly and/or may result in premature wear or damage of the panel, device, or features thereon.

Implementations of the present disclosure provide a latch for a panel of a device to assist the panel in closing against the device. The example latches disclosed herein may assist a panel that may be sagging relative to the device to close against the device. Example latches may correctly align respective and/or associated panels to the device as the panel is closed against the device. Further, example latches disclosed herein may counteract the sagging of respective and/or associated panels by lifting the panels relative to a device such that the panels may close against a device in a correctly aligned manner. Further, example latches disclosed herein may provide a rolling engagement of the latch with the device that may eliminate or minimize a sliding friction between a guide feature of a panel and a receiving feature of the device, thereby avoiding or minimizing premature wear or damage of components of the panel or device.

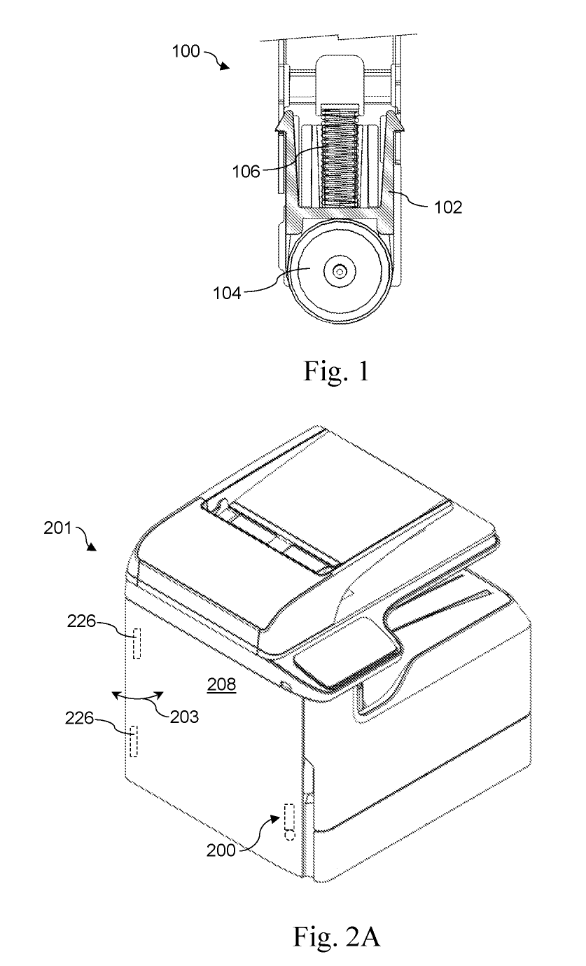

Referring now to FIG. 1, a side view of an example latch 100 is illustrated. In some implementations, the example latch 100 may include a wheel 104, a housing 102 engaged with the wheel 104, and a bias member 106. In further implementations, the housing 102 and the wheel 104 may move together along a side of a panel, and the bias member 106 may bias the wheel 104 and the housing 102 against a direction of movement of the wheel 104 and the housing 102. In yet further implementations, the bias member 106 may exert a reactive force against the panel, or a portion or component thereof or thereon.

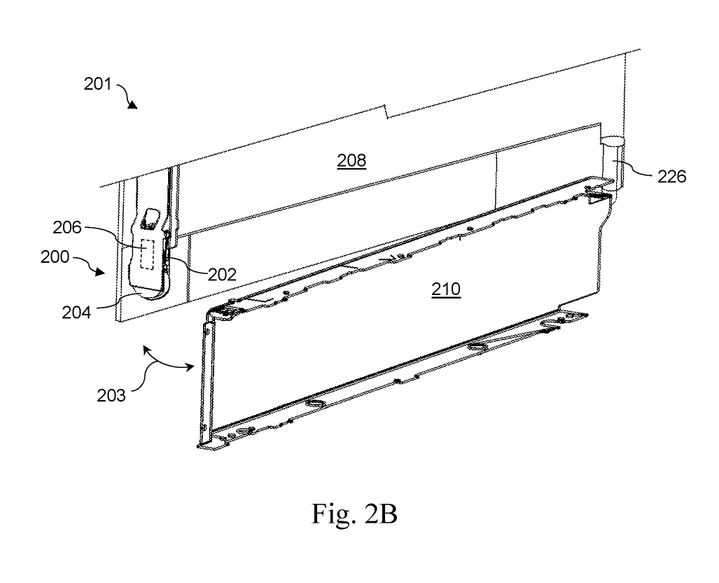

Referring now to FIG. 2A, a perspective view of an example device 201 having an example latch 200 is illustrated. In some implementations, the device 201 may be an electronic device, and, in further implementations, may be an imaging device. Imaging devices may perform actions on or with media or a medium thereof. Such actions may include, but are not limited to, printing, plotting, scanning, copying, and other actions that may be performed on or with media. Media, or a medium thereof, may sometimes be referred to as print media, and may include paper, cardboard, latex, vinyl, or other materials suitable for use in an imaging device. In further implementations, imaging devices may include other devices such as three-dimensional (3D) printers. In other implementations, the device 201 may be an electronic device such as a computing device. Computing devices may include components such as processors, memory, storage disks, or other suitable components.

In some implementations, the device 201 may include a panel 208. The panel 208 may be a removable or openable panel. In further implementations, the panel 208 may be rotatably or hingeably engaged with the device 201. In yet further implementations, the panel 208 may be engaged with the device by a hinge 226, or, in other words, the panel 208 may include a hinge 226 to attach the panel 208 to the device 201 such that the panel 208 may move or rotate relative to the device 201 about the hinge 226. In some implementations, the panel 208 may be engaged with the device 201 by a second hinge 226, and in further implementations, additional hinges 226 may be implemented to engage the panel 208 with the device 201. In some implementations, the hinge 226 or hinges may be disposed along a first side or edge of the panel 208.

The panel 208 may be referred to as a door in some implementations, and may be a rigid or semi-rigid portion of a structure, frame, housing or casing of the device 201. In further implementations, the panel or door 208 may be a portion of an exterior housing, casing, or shell of the device 201. The panel 208 may be openable relative to the device 201 such that internal components, parts, or systems of the device 201 are exposed to the exterior of the device 201 when the panel 208 is in an opened position. In some implementations, some of such internal components may be disposed on an inside surface of the panel 208 itself.

Referring additionally to FIG. 2B, an interior view of an example device 201 is illustrated, wherein the panel 208 is disposed, at least partially, in an opened position. In some implementations, the device 201, or the panel or door 208 thereof may include a latch 200. Example latch 200 may be similar to example latch 100. Further, the similarly named elements of example latch 200 may be similar in function and/or structure to the elements of example latch 100, as they are described above. Accordingly, the latch 200 may include a housing 202, a wheel 204, and a bias member 206 (shown in phantom lines).

In some implementations, the latch 200 may be disposed on or along a second side or edge of the panel 208. In further implementations, the second side or edge and the first side or edge of the panel 208 may be opposite to one another, or, in other words, may be opposite sides or edges of the panel 208. Thus, in some situations, the latch 200 may be disposed opposite to the hinge 226 or hinges 226. In some implementations, the latch 200 may be attached, assembled, or fixed to the panel 208 such that the latch 200 moves with the panel 208 about the hinge 226, for example, along an opening and closing direction represented by arrow 203. In some implementations, the opening and closing direction 203 may be referred to as either an opening direction or a closing direction separately, whenever the panel 208 is described as opening or closing, respectively. For example, the panel 208 may move about the hinge 226 along the closing direction to close the panel against a side of the device 201, or a structure, frame, or chassis thereof. Additionally, for example, the panel 208 may also move about the hinge 226 along the opening direction to open the panel 208 from the device 201, and, in some implementations, to expose or reveal internal components or systems of the device 201.

The device 201 may further include a chassis 210, in some implementations. The chassis 210 may be an internal, or semi-internal component or portion of a component of the device 201. In further implementations, the chassis 210 may be a structural component, or a portion thereof, of the device 201. In some implementations of the present disclosure, the hinge 226 may engage the panel 208 with the chassis 210, or a portion thereof. Therefore, the panel 208 may be attached to or movably engaged with the chassis 210 through the hinge 226 such that the panel 208 may rotate, pivot, or otherwise move relative to the chassis 210 about the hinge 226.

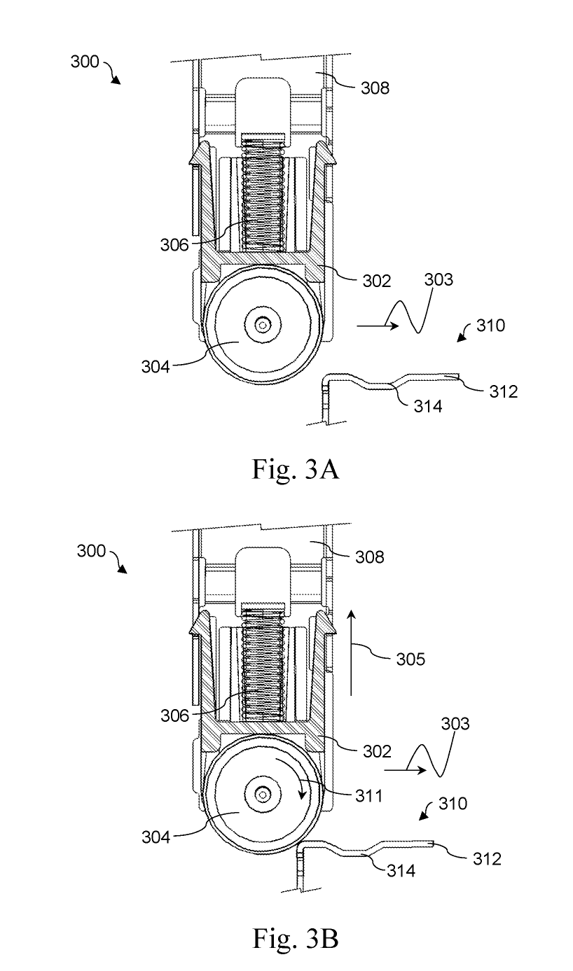

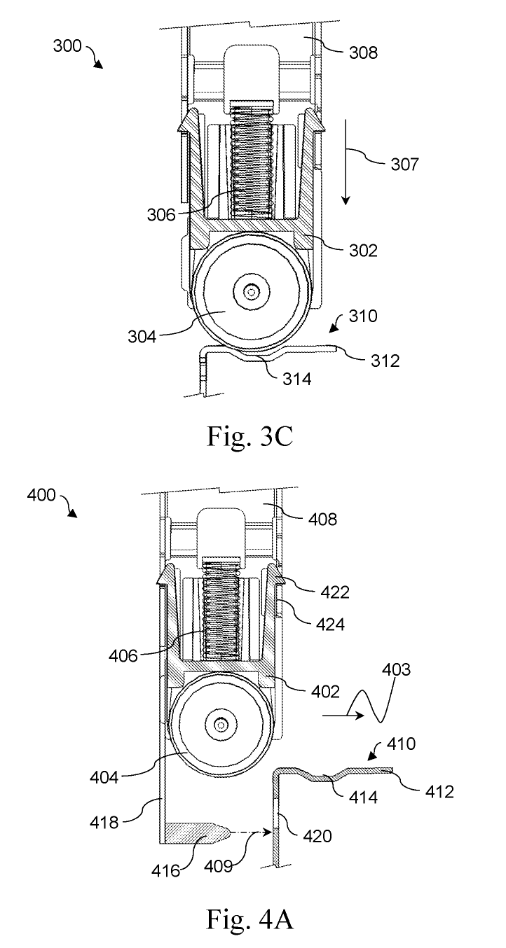

Referring now to FIG. 3A, a side view of an example latch 300 is illustrated. Example latch 300 may be similar to other example latches described above. Further, the similarly named elements of example latch 300 may be similar in function and/or structure to the elements of other example latches, as they are described above. Example latch 300 may include a housing 302, a wheel 304, and a bias member 306, in some implementations. In further implementations, the latch 300 may be disposed on or attached to a panel 308. The panel 308 may be engaged with a device, or a structure or chassis 310 thereof, through a hinge. The chassis 310 may include a receiving portion 312 to engage with or receive the latch 300, or components thereof. Further, the chassis 310 may include a detent 314 to engage with or receive the wheel 304.

The housing 302 may be a rigid or semi-rigid component or member to movably engage the wheel 304 to the panel 308. In some implementations, the housing 302 may be a movable housing 302, and, in further implementations, the housing 302 may be movably engaged with the panel such that the housing 302 may move relative to the panel 308, and move laterally to a closing direction 303 of the panel 308. In some implementations, the housing 302 may move along an axis of rotation of the hinge, and/or along a side of the panel 308. In further implementations, the housing 302 may also move with the panel 308 about the hinge, relative to the device or the chassis 310 thereof, along the closing direction 303. In other words, the latch 300, and/or the components thereof, may be attached to the panel 308 such that the latch 300 moves with the panel 308 along the closing direction 303, relative to the device or the chassis 310 thereof. The housing 302 of the latch 300 may also be capable of moving relative to the panel 308, independently of the movement of the latch 300 with the panel 308 along the closing direction 303.

The wheel 304 may be a component that may be able to rotate relative to the housing 302 and the panel 308. In some implementations, the wheel 304 may be a bearing or another similar rotating component. The wheel 304 may be attached to the housing 302 such that the wheel 304 may move with the housing 302. In other words, independently from the latch 300 and the panel 308 moving along the closing direction 303, the wheel 304 and the housing 302 may move together along the axis of rotation of the hinge, and/or laterally to the closing direction 303 of the panel 308.

The bias member 306 may be a resilient component that may be capable of elastic deformation. In other words, the bias member 306 may be able to return to its original shape after undergoing a deformation. The bias member 306, in some implementations, may exert a reactive force in response to undergoing or experiencing a deformation. In further implementations, the reactive force may be proportional to the degree of deformation, or, in other words, the reactive force exerted by the bias member 306 may increase according to an increase in the degree of deformation that the bias member 306 experiences. In some implementations, the bias member 306 may be a spring such as a compression spring. In other implementations, the bias member 306 may be another type of spring, such as an extension spring, or a torsion spring, for example. In further implementations, the bias member may comprise a metallic material, such as steel or spring steel, or another suitable material.

The bias member 306 may be operably disposed in between the housing 302 and the panel 308 in some implementations. In other words, the bias member 306 may resist movement of the housing 302 relative to the panel 308. In further implementations, the bias member 306 may bias the wheel 304 and housing 302 against the direction of movement of the housing 302 and the wheel 304 relative to the panel 308. Stated differently, the bias member 306 may resist the movement of the wheel 304 and the housing 303 together laterally to the closing direction 303.

Referring now to FIG. 3B, a side view of an example latch 300 is illustrated wherein the latch 300 has moved with the panel 308 along the closing direction 303 and has come into contact with and started to engage with the chassis 310, and/or a contacting component thereof, such as the receiving portion 312, the detent 314, or an edge or leading edge of the detent 314. The chassis 310 may include the detent 314 to receive the wheel 304 of the latch 300 upon the panel 308 closing against the chassis 310. In some implementations, a user or other external motivating element may cause the panel 308 to move along the closing direction 303. Upon the latch 300 or the wheel 304 thereof coming into contact with the chassis 310, or another contacting component thereof, such as a leading edge of the detent 314, for example, the wheel 304 may begin to rotate in a direction consistent with the closing direction 303. Such rotation of the wheel 304 may be represented by arrow 311, in some implementations, and may be caused by friction in between an outer surface of the wheel 304 and the chassis 310, or the portion thereof contacting the wheel 304. Thus, in some implementations, the wheel 304 may engage with the edge of the detent 314 in a rolling manner to be received by the detent 314.

Additionally, the contact in between the wheel 304 and the chassis 310, or the contacting component thereof, may cause the wheel 304 to push, translate, or otherwise move in a direction 305 lateral to the closing direction 303. Accordingly, the wheel 304 may cause the housing 302 to also move in a direction 305, relative to the panel 308. In other words, in some implementations, the edge of the detent 314 may move the wheel 304 and the housing 302 laterally to the closing direction 303 against the resistance of the bias member 306 when the wheel 304 comes into contact with the edge of the detent 314 throughout the travel of the panel 308 along the closing direction 303.

In some implementations, the wheel 304 and the housing 302 may move together along the direction 305 against the urging of the bias member 306, or, in other words, the wheel 304 and the housing 302 may resistively move together against the bias member 306. In implementations wherein the bias member 306 is a compression spring, such movement of the wheel 304 and the housing 302 may compress or squeeze the bias member 306, thus deforming the bias member 306 and causing the bias member 306 to exert a reactive force on the panel 308 along the same direction as the deformation of the bias member 306. Such a reactive force may be along the direction 305, thus urging or forcing the panel 308 to move along direction 305. In further implementations, direction 305 may be against the force of gravity, and thus the bias member 306 may urge or force the panel 308 to move against its own weight or mass. In other words, the wheel 304 may cause the bias member 306 to exert a lifting force against the panel 308 if the wheel 304 engages with the chassis 310, or another contacting component thereof, such as the receiving portion 312, the detent 314, or an edge of the detent 314, for example. Such a lifting force may cause the panel 308 to become properly aligned with the device or the chassis 310 thereof so that the panel 308 may correctly and completely close against the device or the chassis 310.

Referring now to FIG. 3C, a side view of the example latch 300 is illustrated wherein the panel 308 has continued to move along the closing direction 303 until the panel 308 has reached a closed position, or a position wherein the panel 308 is closed against the device or the chassis 310 thereof. In some implementations, upon reaching the closed position, the wheel 304 of the latch 300 may engage with the detent 314. In further implementations, the wheel 304 may engage with the detent 314 so as to retain the panel 308 in the closed position. Upon the wheel 304 reaching the detent, the bias member 306 may exert a reactive force along direction 307 in order to urge the wheel 304 into the detent 314 and to retain the wheel 304 within the detent 314. In some implementations, the bias member 306 may be assisted by the force of gravity, or, in other words, the weight of the panel 308, in urging the wheel 304 into the detent 314. In further implementations, and as is illustrated in FIG. 3C, the wheel 304 may only partially engage with the detent 314 upon the panel 308 reaching the closed position. In such a situation, the wheel 304 may be urged by the bias member 306 and/or the weight of the panel 308 against a downward slope of the detent 314. This partial engagement of the wheel 304 with the detent 314 may ensure that the wheel 304, by way of the bias member 306, tightly retains the panel 308 in the closed position. In other implementations, the wheel 304 may completely engage with the detent 314 when the panel 308 is in the closed position.

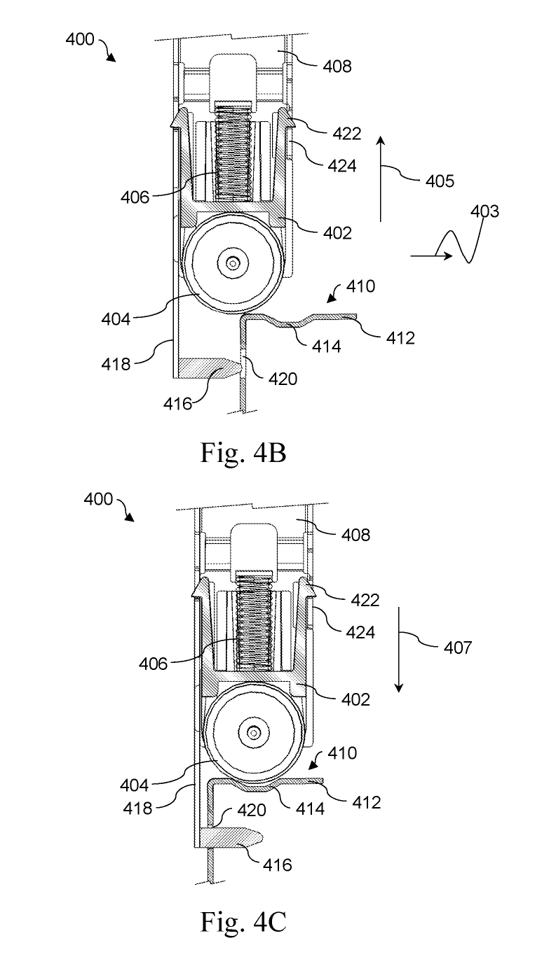

Referring now to FIG. 4A, a side view of an example latch 400 is illustrated. Example latch 400 may be similar to other example latches described above. Further, the similarly named elements of example latch 400 may be similar in function and/or structure to the elements of other example latches, as they are described above. In addition to some or all of the above-described components, the latch 400 may further include a guide pin 416. The guide pin 416 may engage with an alignment orifice 420 of a device, or a chassis 410 thereof. In some implementations, the guide pin 416 may be rigidly attached to or disposed on the panel 408, or another component thereof, such as an alignment arm 418. In other implementations, the guide pin 416 may be attached to another component of the latch 400. The guide pin 416, in some implementations, may be a post, pin, rod, or another protrusion. Accordingly, the alignment orifice 420 may be a receiving feature such as a receptacle, cavity, or other suitable element and may be sized sufficiently to receive the guide pin 416 within. In some implementations, the guide pin 416 may have a chamfer or angled leading edge to assist in aligning the guide pin 416 with the alignment orifice 420 should they be misaligned, and, thus also correcting alignment between the panel 408 and the device or the chassis 410 thereof. In further implementations, the guide pin 416 may be disposed on the chassis 410, and the alignment orifice 420 may be disposed on the panel 408 or latch 400.

In some implementations, when the panel 408 is disposed in an open position, the weight or mass of the panel 408 may cause the panel 408 to sag or hang out of correct alignment with the device or chassis 410 thereof. As such, when the panel 408 is in the open position, the guide pin 416 may be misaligned with the alignment orifice 420 of the chassis 410. In some implementations, such misalignment may be to such a degree that a chamfer or angled leading edge of the guide pin 416 is incapable of correcting the alignment of the panel 408 with the device or chassis 410. Such misalignment may be represented by arrow 409. Thus, in some implementations, if the latch 400 were not present, the panel 408 may not correctly or completely move along a closing direction 403 to a closed position against the device or chassis 410 thereof. As such, the latch 400 may assist in correctly aligning the guide pin 416 with the alignment receptacle 420, and the panel 408 with the device and/or chassis 410 as the panel 408 moves along closing direction 403.

Referring now to FIGS. 4B-4C side views of the example latch 400 are illustrated wherein the latch 400 has started to engage with the chassis 410, or a contacting component thereof, and wherein the panel 408 has completely moved along closing direction 403 to a closed position against the device or chassis 410, respectively. In some implementations, as a wheel 404 initially comes into contact with the chassis 410, or, for example, a leading edge of a detent 414 thereof, such contact may cause the wheel 404 to rotate up and over the leading edge of the detent 414, thus moving with a housing 402 in a direction 405 lateral to the closing direction 403. Such movement in direction 405 may cause a bias member 406 to deform and exert a corresponding reactive force along direction 405 against the panel 408, thereby lifting or otherwise moving the panel 408 along direction 405. Such movement of the panel 408 may cause the panel 408 to become correctly or sufficiently aligned with the device or chassis 410 thereof so that the panel 408 may close against the device. Additionally, such movement of the panel 408 may cause the guide pin 416 to move in a similar manner and become aligned with the alignment orifice 420 such that the guide pin 416 may be received by the alignment orifice 420. In other words, the wheel 404 may engage with the chassis 410 to move the latch 400 such that the guide pin 416 moves from an unaligned position to an aligned position with the alignment orifice 420. Accordingly, and as illustrated in FIG. 4C, the panel 408 may continue to move along the closing direction 403 until the panel reaches a closed position wherein the panel 408 is completely and correctly closed against the device or chassis 410 thereof, and the guide pin 416 is received within the alignment orifice 420. Upon reaching the closed position, the bias member 406, and/or the weight of the panel 408, may urge, force, or move the wheel 404 in a direction 407 such that the wheel 404 becomes engaged with the detent 414.

Additionally, in some implementations, the housing 402 of the latch 400 may include a retaining hook 422 to engage with a retention edge 424 of the panel 408. The retaining hook 422 may allow movement of the housing 402 along an axis of rotation of a hinge, or along directions 405 and 407, lateral to the closing direction 403. In further implementations, the housing 402 may include additional retaining hooks 422, each to engage with a retention edge 424 of the panel 408. In some implementations, the retaining hook or hooks 422 may limit the amount of travel of the housing 402 along direction 407, or a direction along which the bias member 406 may urge, force, or move the housing 402. Thus, the retaining hook or hooks 422 may prevent the bias member 406 from disengaging or removing the housing 402 or other components of the latch 400 from the panel 408.

What is claimed is:

1. A panel, comprising:
a latch, comprising:
a wheel;
a housing engaged with the wheel, the housing and wheel to move together along a side of the panel; and
a bias member to bias the wheel and housing against the direction of movement of the housing and wheel, the bias member to exert a reactive force against the panel.

2. The panel of claim 1, further comprising a hinge, wherein the latch is to move with the panel about the hinge.

3. The panel of claim 2, wherein the wheel and the housing are to move together along an axis of rotation of the hinge.

4. The panel of claim 3, wherein the wheel and the housing are to resistively move together against the bias member.

5. The panel of claim 4, wherein the bias member is to resist the movement of the wheel and the housing together so as to apply a lifting force against the panel.

6. The latch of claim 4, wherein the housing further includes a retaining hook to engage with a retention edge of the panel, the retaining hook to allow movement of the housing along the axis of rotation of the hinge.

7. A door, comprising:
a hinge disposed on a first side of the door; and
a latch disposed on a second side of the door, the latch to move with the door about the hinge and comprising:
a movable housing to move laterally to a closing direction of the door;
a wheel attached to the housing and to move with the housing; and
a bias member to bias the wheel and housing in a direction laterally to the closing direction of the door.

8. The door of claim 7, wherein the first side of the door and the second side of the door are opposite to one another.

9. The door of claim 7, wherein the latch further comprises a guide pin to engage with an alignment orifice of a chassis.

10. The door of claim 9, wherein the wheel is to engage with the chassis to move the latch such that the guide pin moves from an unaligned position to an aligned position with the alignment orifice.

11. An imaging device, comprising:
a door having a hinge disposed on a first side to engage the door with a chassis of the imaging device, the door to move about the hinge along a closing direction to close against a side of the chassis;
a latch disposed on a second side of the door and to move with the door, comprising:
a movable housing;
a wheel attached to the housing, the wheel and the housing to move together laterally to the closing direction of the door; and
a bias member to resist the movement of the wheel and housing laterally to the closing direction.

12. The imaging device of claim 11, wherein the chassis comprises a detent to receive the wheel of the latch if the door closes against the chassis.

13. The imaging device of claim 12, wherein an edge of the detent is to move the wheel and housing laterally to the closing direction against the resistance of the bias member if the wheel comes into contact with the edge of the detent throughout the travel of the door along the closing direction.

14. The imaging device of claim 13, wherein the wheel is to cause the bias member to exert a lifting force against the door if the wheel engages with the edge of the detent.

15. The imaging device of claim 14, wherein the wheel is to engage with the edge of the detent in a rolling manner to be received by the detent.
